(19) United States
(12) Patent Application Publication
(10) Pub. No.: US 2009/0055816 A1
(43) Pub. Date: Feb. 26, 2009

(54) Information processing apparatus, update method, and program

(75) Inventor: Keishi Akada, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/229,245

(22) Filed: Aug. 20, 2008

(30) Foreign Application Priority Data
Aug. 23, 2007 (JP) P2007-216635

(51) Int. Cl. G06F 9/44

(52) U.S. Cl. 717/168

(57) ABSTRACT

An information processing apparatus includes: a storage part configured to store therein an update process executing program core which is a partial program configuring an update process executing program applied to an update process for a data processing program stored in the information processing apparatus; and a control part configured to start the update process executing program core in the update process for the data processing program, acquire an update process executing program body which is a partial program configuring the update process executing program through a recording medium or over a network, and apply the update process executing program body to perform the update process for the data processing program.

### CROSS REFERENCES TO RELATED APPLICATIONS

The present invention contains subject matter related to Japanese Patent Application JP 2007-216635 filed in the Japanese Patent Office on Aug. 23, 2007, the entire contents of which being incorporated herein by reference.

### BACKGROUND OF THE INVENTION

1. Field of the Invention

The present invention relates to an information processing apparatus, an update method, and a program. More specifically, the invention relates to an information processing apparatus, an update method, and a program which update a program.

2. Description of the Related Art

For example, in a digital still camera, a video camera, a television set, a PC (personal computer), and various other information processing apparatuses, a data processing program for executing a process in accordance with individual apparatuses is recorded in advance in a non-volatile memory, and offered to a user. The user uses the program installed in advance in the apparatus to perform various processes.

In such apparatuses having a program installed therein, programs, that is, software is increasing its scale and becoming more complicated for more advanced processing. Under these situations, for example, necessities are found in various apparatuses to add a function or to correct a problem after apparatuses having a program installed therein are shipped.

In the case in which a function is added or a problem is corrected as described above, a program to add a function or a program to correct a problem is distributed to a user through a recording medium, or over a network. It is necessary for the user to acquire a program to add a function or to correct a problem through a recording medium or over a network and to update the installed program by him/herself. In addition, for example, there is JP-A-2006-189975 as a technique before that discloses an update process for a program.

In the apparatus having a program installed therein in recent years, in order to reduce costs and to stably supply products, there are some schemes such as the configuration in which common components are used for different products, for example, products using devices made of a plurality of manufacturers, and providing different settings of software depending on destination countries. For example, even the same digital still cameras often have different programs for use in individual versions of products or individual destination countries.

More specifically, for example, even the same digital still cameras have programs with different settings installed therein as follows:

Product A destined for Japan has program AJ,

Product A destined for Europe has program AE,

Product A destined for U.S.A. has program AU,

Product B destined for Japan has program BJ,

Product B destined for Europe has program BE, and

Product B destined for U.S.A. has program BU.

As described above, it often happens that even the same digital still cameras store therein programs slightly different from each other.

In the apparatuses having a program installed therein such as a digital still camera before, in consideration of the possibilities of adding a function and correcting the program already installed in the apparatus, many of them are configured in which an update process executing program (updater) for executing a program update process is recorded in a flash memory, and the update process executing program (updater) is used to update the existing program based on a program of adding a function or correcting the program.

However, as described above, in the situations in which even the same digital still cameras have data processing programs for use different in individual versions of products or individual destination countries, it is necessary for the update process executing program (updater) for executing the program update process to also use an update process executing program corresponding to the individual data processing programs, that is, the update process executing programs different in individual versions of products or individual destination countries.

In the case in which the data processing program targeted for update is a program different in individual versions of products or individual destination countries, ideally, the optimum update process executing program (updater) corresponding to each of the data processing programs is installed in advance in the apparatus. However, in order to make an optimum update process executing program (updater) corresponding to each of the data processing programs, it is necessary to conduct studies for adding a function and correcting the program thought in advance in accordance with each of the data processing programs.

However, in order to prepare the optimum update process executing program (updater) corresponding to the data processing program different in individual versions of products and individual destination countries in the stage of shipping products and to install the optimum program in products, it is necessary to conduct studies for adding a function and correcting the program thought in advance in accordance with a large number of data processing programs, which will be a process taking a long time and costs. Consequently, it will be a factor for a cause to delay shipment.

### SUMMARY OF THE INVENTION

It is desirable to provide an information processing apparatus, an update method, and a program, in which in the configuration of executing an update process for a program stored in an information processing apparatus such as a digital still camera, such a configuration is implemented that an update process executing program (updater) to be recorded in an apparatus in the stage of shipping products can be provided as a common program even though versions of products or destination countries, for example, are different and different individual data processing programs can be reliably updated.

An information processing apparatus according to an embodiment of the invention is an information processing apparatus including: a storage part configured to store therein an update process executing program core which is a partial program configuring an update process executing program applied to an update process for a data processing program stored in the information processing apparatus; and a control part configured to start the update process executing program core in the update process for the data processing program, acquire an update process executing program body which is a partial program configuring the update process executing program through a recording medium or over a network, and apply the update process executing program body to perform the update process for the data processing program.

In the information processing apparatus according to the embodiment of the invention, the update process executing program core stored in the storage part may be a program stored as a program common to information processing apparatuses having a plurality of different data processing programs, and the update process executing program body acquired through the recording medium or over the network is a program set as it corresponds to individual data processing programs in order to perform different update processes corresponding individually to the different data processing programs.

In the information processing apparatus according to the embodiment of the invention, the update process executing program core stored in the storage part may be a program which performs a hardware initialization process necessary for the update process for the data processing program executed in the information processing apparatus and the acquiring process for the update process executing program body.

In the information processing apparatus according to the embodiment of the invention, the control part may load the update process executing program body acquired through the recording medium or over the network to a ROM of the information processing apparatus to perform the update process for the data processing program to which the update process executing program body is applied, and after the update process, the control part ends the update process without recording the update process executing program body in the storage part.

In the information processing apparatus according to the embodiment of the invention, the storage part may have a configuration in which device configuration information of the information processing apparatus is stored, and the control part may apply the update process executing program body to acquire the device configuration information and performs the update process for the data processing program.

In the information processing apparatus according to the embodiment of the invention, the device configuration information may include at least any of items of configuration information of hardware and software provided in the information processing apparatus.

In the information processing apparatus according to the embodiment of the invention, the control part may apply the update process executing program body to perform an update process of the update process executing program core.

An update method according to an embodiment of the invention is an update method of a data processing program including steps of: starting an update process executing program core applied to an update process for a data processing program stored in the information processing apparatus and acquiring an update process executing program body which is a partial program configuring the update process executing program through a recording medium or over a network; and applying the update process executing program body and performing the update process for the data processing program.

A program according to an embodiment of the invention is a program which allows a computer to perform an update method of a data processing program, the method including the steps of: starting an update process executing program core applied to an update process for a data processing program stored in the information processing apparatus and acquiring an update process executing program body which is a partial program configuring the update process executing program through a recording medium or over a network; and applying the update process executing program body and performing the update process for the data processing program.

### BRIEF DESCRIPTION OF THE DRAWINGS

FIG. 1 shows a diagram illustrative of an exemplary configuration and process of an information processing apparatus according to an embodiment of the invention;

FIG. 2 shows a diagram illustrative of the configuration of programs stored and programs acquired in the information processing apparatus according to an embodiment of the invention;

FIG. 3 shows a diagram illustrative of programs distributed through a medium or a server to information processing apparatuses;

FIG. 4 shows a flow chart illustrative of the sequence of a program update process executed in the information processing apparatus according to an embodiment of the invention; and

FIG. 5 shows a diagram illustrative of an exemplary configuration of a digital still camera which is the information processing apparatus according to an embodiment of the invention.

### DESCRIPTION OF THE PREFERRED EMBODIMENTS

Hereinafter, the detail of an information processing apparatus, an update method, and a program according to an embodiment of the invention will be described with reference to the drawings.

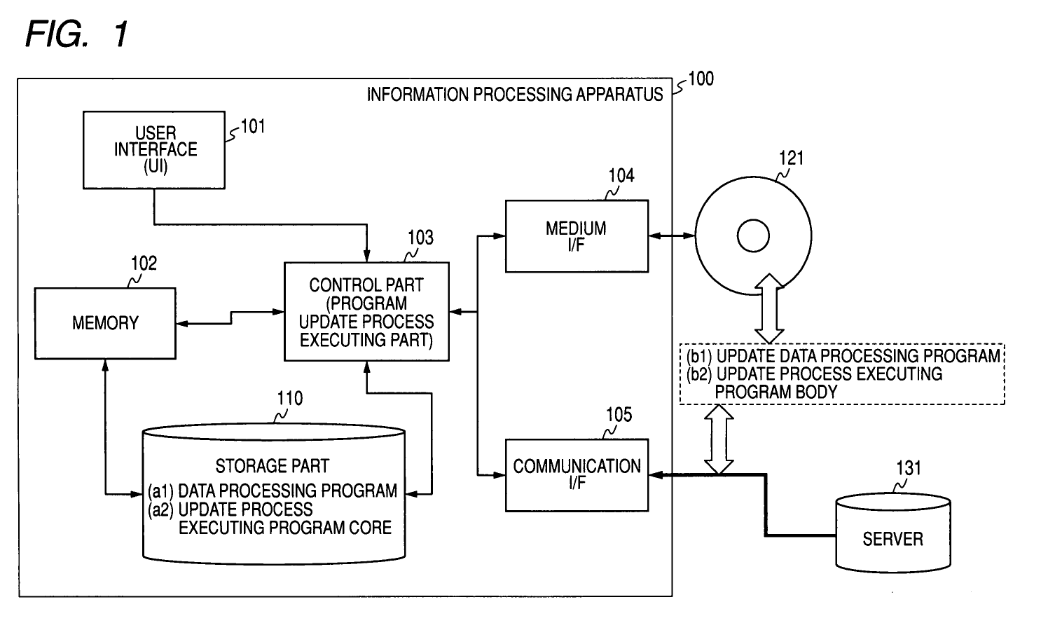

A process executed by the information processing apparatus according to the embodiment of the invention will be described with reference to FIG. 1. FIG. 1 shows a diagram illustrative of the process configuration of executing a program update process in an information processing apparatus 100 according to the embodiment of the invention. For example, the information processing apparatus 100 according to the embodiment of the invention is a digital still camera, a video camera, a television set, a PC, and various other information processing apparatuses, in which a program (data processing program) for data processing is stored in advance in a storage part 110, and the program (data processing program) stored in the storage part 110 is executed under control performed by a control part 103, whereby processing is performed according to apparatuses. For example, the storage part 110 is a non-volatile memory such as a flash ROM.

For example, in the case in which the information processing apparatus 100 is a digital still camera, the program (data processing program) stored in the storage part 110 is various data processing programs for performing processes executed by the digital still camera such as a program for an imaging process executed by the digital still camera, a program for generating images displayed on the monitor of the digital still camera, and a program for displaying images.

The data processing program is stored in advance in the storage part 110 in fabricating the information processing apparatus 100, and offered to a user. In the case in which necessities are found to add a function of a program or correct the program after the apparatus is provided to the user, for example, a manufacturer of the information processing apparatus 100 stores an update data processing program for adding a function or correcting the program in an external recording medium 121, and offers it. Alternatively, the manufacturer distributes it through a server 131 over a network.

Under control performed by the control part (program update process executing part) 103, the information processing apparatus 100 reads the program distributed through the external recording medium 121 via a medium I/F 104. Alternatively, the information processing apparatus 100 reads the program distributed through the server 131 over the network through a communication I/F 105.

In the case in which the control part (program update process executing part) 103 performs an update process for a data processing program (a1) stored in the storage part 110, the control part 103 performs an update process using an update process executing program core (a2) stored in the storage part 110 and an update process executing program body (b2) distributed together with an update data processing program (b1) through the external recording medium 121 or the server 131.

In performing the update process for the data processing program (a1) stored in the storage part 110, the control part (program update process executing part) 103 starts the update process executing program core (a2) stored in the storage part 110, acquires the update data processing program (b1) and the update process executing program body (b2) which is a partial program configuring the update process executing program through the external recording medium 121 or the server 131 over the network, and updates the data processing program by the update process to which the update process executing program body is applied, or the update process to which both of the update process executing program core and the update process executing program body are applied.

The information processing apparatus 100 according to the embodiment of the invention stores a part (update process executing program core) of the update process executing program in advance in the storage part 110 configured of a non-volatile memory such as a flash ROM, and acquires a part (update process executing program body) through the external recording medium 121 or the server 131 together with the update data processing program.

The update process executing program core (a2) stored in advance in the storage part 110 is configured of the function of initializing hardware necessary at the minimum in the update process for the data processing program and a part of the function of updating the program (updater function) such as the function of reading data distributed through the external recording medium 121 or the server 131.

The update process executing program body (b2) distributed through the external recording medium 121 or the server 131 together with the update data processing program is the remaining part of the updater function serving as the full updater function by cooperating with the update process executing program core (a2). The update process executing program body (b2) is distributed with the function of updating parameters in accordance with the configuration or function of the information processing apparatus 100, whereby a flexible update is made possible which is matched with the data processing program in accordance with individual apparatuses even though the update process executing program core (a2) that is a program common to the information processing apparatuses 100 having different functions is made common to various apparatuses.

For example, when a request to start the program update process is inputted through a user interface 101, the control part (program update process executing part) 103 starts the update process executing program core stored in advance in the storage part 110, reads the update process executing program body out of the external recording medium 121 or the server 131, and loads it in a memory (RAM) 102. After that, the control part 103 rewrites an old data processing program stored in the storage part 110 by executing the program of the update process executing program body, or by executing the program using both of the update process executing program core and the update process executing program body, or by executing the update data processing program read out of the external recording medium 121 or the server 131.

The memory 102 is used as a storage area and a work area for the update process executing program body and parameters for use in performing the update process.

By control performed by the control part (program update process executing part) 103, the update of the data processing program is finished by executing the program using both of the update process executing program core and the update process executing program body, and then the update process executing program body loaded to the memory (RAM) 102 is erased. The control part (program update process executing part) 103 ends the update process without recording the update process executing program body in the storage part 110.

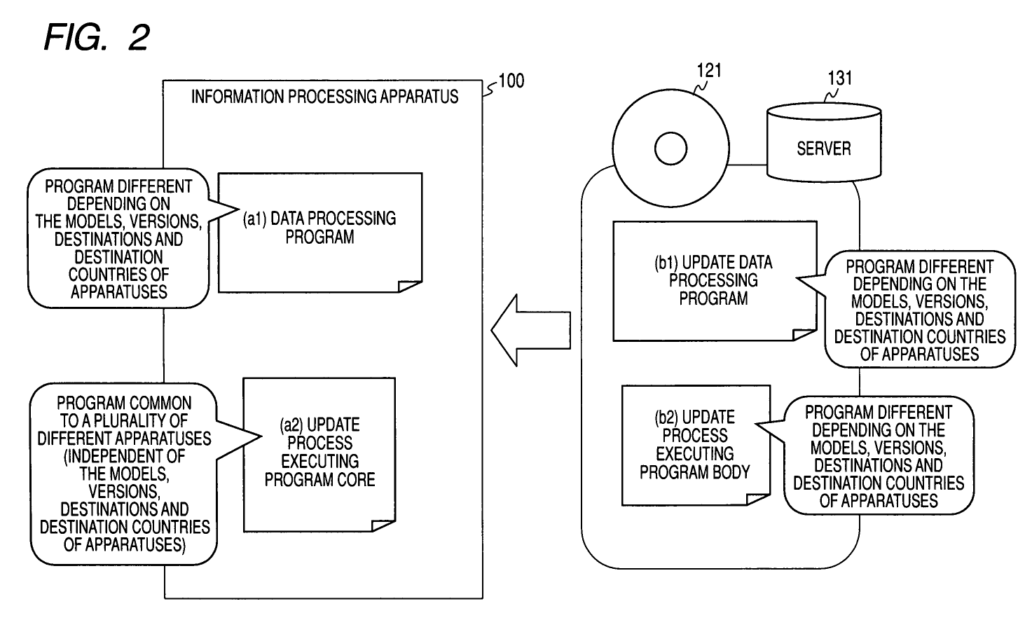

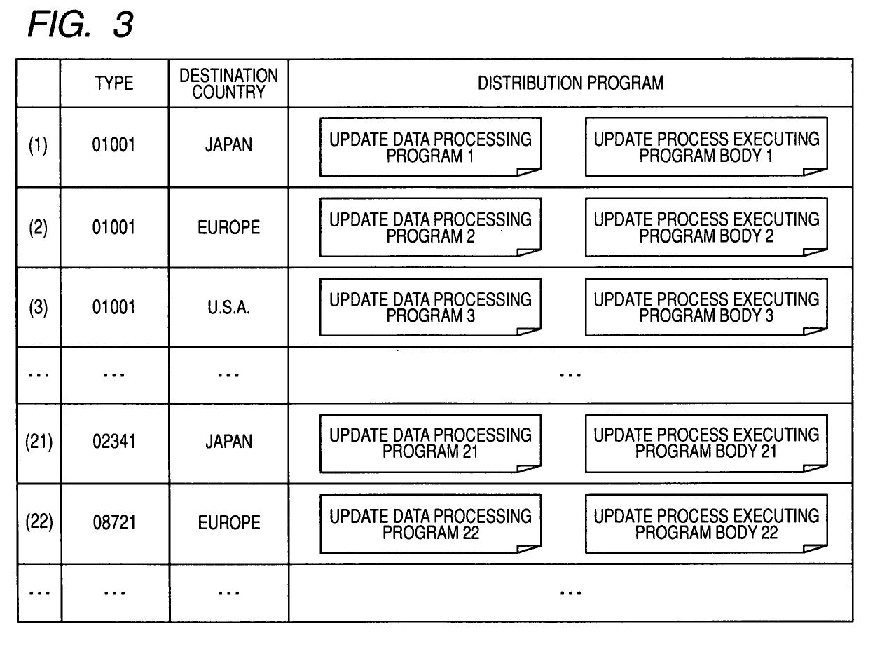

The correspondence between the update process executing program core stored in advance in the storage part 110 and the update process executing program body distributed through the external recording medium 121 or the server 131 will be described with reference to FIGS. 2 and 3.

As shown in FIG. 2, in the information processing apparatus 100, the storage part stores in advance therein the following programs:

the data processing program (a1), and

update process executing program core (a2).

The data processing program (a1) is a program applied to data processing executed by the information processing apparatus, and for example, in a digital still camera, it is a program for executing the imaging process and the image displaying process. For instance, the data processing program is a program different in individual versions of products or individual destination countries.

For example, the data processing program is a program different in individual destination countries; in the apparatuses destined for Japan, such a data processing program is installed that can represent Japanese, and in the apparatuses destined for English-speaking countries, such a program is installed that can represent English only. In addition, in the case in which executing functions are different depending on the types of apparatuses, the program corresponding to these executing functions is installed in accordance with apparatuses.

The update process executing program core (a2) is a part of a program for executing the update process for the data processing program. For example, the update process executing program core is a program only including a common update program usable in a plurality of data processing programs different in individual versions of products or individual destination countries and is a common program applied to the different versions or apparatuses for different destination countries in which different data processing programs are installed, and the update process executing program core is installed common in the different versions or apparatuses for different destination countries.

For example, the update process executing program core stored in the storage part 110 is configured as a program for executing a hardware initialization process necessary for the update process for the data processing program executed in the information processing apparatus 100 and the acquiring process for the update process executing program body.

On the other hand, the following is the programs distributed through the external recording medium 121 or the server 131:

the update data processing program (b1), and

the update process executing program body (b2).

The update data processing program (b1) is a program including update information for the data processing program (a1) stored in the information processing apparatus, and for example, in a digital still camera, it is an update version of the program for executing the imaging process and the image displaying process. As similar to the data processing program, for example, the update data processing program is a program different in individual versions of products or individual destination countries. In other words, the update data processing program is set as it corresponds to the individual data processing programs (a1) different in individual versions of products or individual destination countries.

The update process executing program body (b2) is a part of the program for executing the update process for the data processing program, which is executed in the control part 103 together with the update process executing program core (a2) stored in the information processing apparatus, whereby the data processing program can be updated.

The update process executing program body is set as it corresponds to the data processing program (a1) different in individual versions of products or individual destination countries, and is different in individual versions of products or destination countries.

For the following programs distributed through the external recording medium 121 or the server 131, that is,

the update data processing program (b1), and

the update process executing program body (b2),

the combinations of these programs are set and offered depending on versions of products or individual destination countries as shown in FIG. 3, for example.

As shown in FIG. 3, combination data is distributed as follows:

(1) to an information processing apparatus, model=01001 and a destination country=Japan, combination data of update data processing program 1 and update process executing program body 1 is distributed;

(2) to an information processing apparatus, model=01001 and a destination country=Europe, combination data of update data processing program 2 and update process executing program body 2 is distributed; and

(3) to an information processing apparatus, model=01001 and a destination country=U.S.A., combination data of update data processing program 3 and update process executing program body 3 is distributed.

Hereinafter, similarly, combination data of update data processing program k and update process executing program body k is distributed, which is decided depending on the model and the destination country, where k=any one of 1 to n, if there are n type of data processing programs.

In addition, in the example described here, the combinations of the update data processing program k and the update process executing program body k are changed depending on the model and the destination country of the information processing apparatus. However, the variety of configurations are possible in which the combination of data can be changed depending on various other conditions of apparatuses such as shipping periods, manufacturers, and used devices.

The combinations of the update data processing program k and the update process executing program body k are to be changed in accordance with the data processing program stored in the information processing apparatus. In other words, the data processing program stored in advance in the information processing apparatus is different depending on the model and the destination country of the information processing apparatus, for example. Also for the update data processing program k and the update process executing program body k, different combinations are set depending on the data processing program stored in advance in the information processing apparatus, and in the update process, the update data processing program k and the update process executing program body k are used which are selected as they correspond to the data processing program stored in advance in the information processing apparatus.

In addition, the combinations of the update data processing program k and the update process executing program body k to be offered to the information processing apparatus 100 through the external recording medium 121 or the server 131 may be the combination of only a pair of programs corresponding to the data processing program stored in advance in the information processing apparatus, or may be such a configuration that all the combinations of update data processing programs 1 to n and update process executing program bodies 1 to n are offered to the information processing apparatus and the combination of the update data processing program k and the update process executing program body k is selected in the control part 103 of the information processing apparatus 100 in accordance with the data processing program stored in the storage part 110 of the information processing apparatus 100.

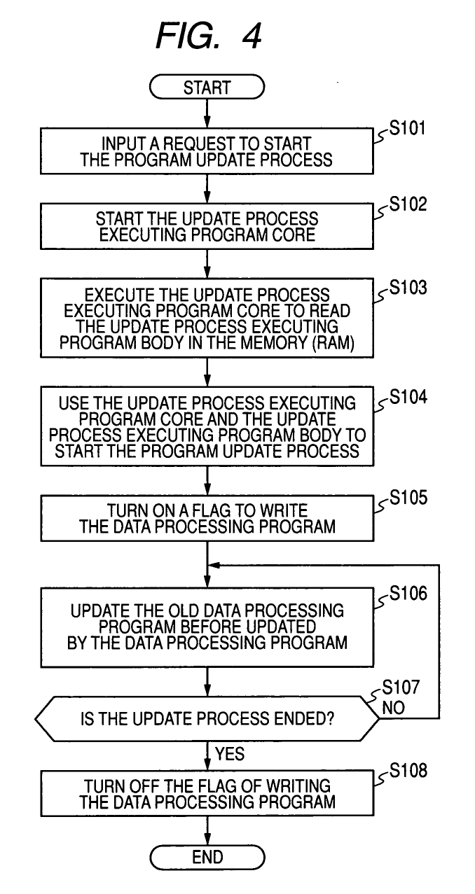

Next, the sequence of the update process for the data processing program executed in the information processing apparatus according to the embodiment of the invention will be described with reference to FIG. 4. The flow shown in FIG. 4 is conducted under control performed by the control part 103 of the information processing apparatus 100 shown in FIG. 1. In addition, at the point of starting this flow, the information processing apparatus 100 is set so that it can read the update data processing program (b1) and the update process executing program body (b2) out of the external recording medium 121 or the server 131.

First, in Step S101, a request to start the program update process is inputted. For example, through the user interface 101 of the information processing apparatus shown in FIG. 1, a user inputs a request to start the program update process.

When the request to start the program update process is inputted, in Step S102, the control part 103 starts the update process executing program core stored in the storage part 110. The update process executing program core is loaded from the storage part 110 configured of a non-volatile memory such as a flash ROM to the memory (RAM) 102, and the process is moved to the updater core.

In Step S103, the control part 103 executes the update process executing program core read out of the storage part 110 to read an update process executing program body to the memory (RAM) 102. The update process executing program body is acquired through the external recording medium 121 or the server 131, and loaded to the memory (RAM) 102. In other words, the update process executing program core (updater core) searches the external recording medium 121 or the server 131 for an update data processing program to be update data and the update process executing program body (updater body).

When a file that can be recognized as update data is found, the update process executing program body included in that file is read in the RAM, and the process is moved to the update process executing program body.

In addition, if a file that can be recognized as update data is not found on the external recording medium 121 or the server 131, a message is displayed which notifies to the user interface 101 that no file for the update process is found. Alternatively, a user is notified that no file is found by flashing an LED for error indication provided on the information processing apparatus 100.

Subsequently, in Step S104, the control part 103 applies the update process executing program body, or both of the update process executing program core and the update process executing program body to start the update process for the old data processing program stored in the storage part 110.

In addition, for example, in the case in which the update process executing program core is configured as it is limited to the minimum function of initializing hardware necessary in the update process for the data processing program and the function of reading data distributed through the external recording medium 121 or the server 131, the update process for the data processing program actually executed is a process using only the update process executing program body.

In addition, such a configuration may be possible that the update process executing program core is not limited to the function of initializing hardware and the function of reading data and a common update process is performed which is necessary to update a plurality of different data processing programs. In this case, the update process for the data processing program is performed by using both of the update process executing program core and the update process executing program body.

The update process executing program core is configured as a program that can be used in common even though the data processing program stored in advance in the storage part 110 of the information processing apparatus 100 is different, that is, as a program that performs the function of initializing hardware, reads data out of the external recording medium 121 or the server 131, and performs the update process common to the different data processing programs.

On the other hand, by executing the update process executing program core, the update process executing program body read out of the external recording medium 121 or the server 131 is the remaining part of the updater function serving as the full updater function by cooperating with the update process executing program core.

The update process executing program body is a program having the updating function in accordance with the individual data processing programs different depending on the configuration or function of the information processing apparatus 100, that is, individual versions or destination countries of the apparatus. For example, the update process executing program body provides the updating function in accordance with the data processing program supporting a particular language, or the updating function in accordance with the data processing program for executing a unique function included in a particular version of an apparatus. In other words, the update process executing program body is a program that is set as it corresponds to the individual data processing programs in order to execute the update process differently provided for the individual different data processing programs.

As described above, in the information processing apparatus according to the embodiment of the invention, it is configured in which the programs are categorized as: the update process executing program core that is a program usable for a plurality of the data processing programs in common, and the update process executing program body that is a program for executing a unique update process provided for individual data processing programs, only the update process executing program core is stored in advance in the storage part 110 inside the information processing apparatus 100, and the update process executing program body is distributed through the external recording medium 121 or the server 131 together with the data processing program applied to the update process. With this configuration, even though the update process executing program core is made common to various apparatuses, flexible update can be made possible which corresponds to the data processing program provided for individual apparatuses.

In Step S105, the control part 103 turns on a flag of writing the data processing program. This process is for the flag indicating the executing period of the update process for the data processing program, and is a process for avoiding the execution of general data processing. In addition, for the start of updating the data processing program, and the progress and the end of processing, these events are represented to a user through the user interface 101. In performing the program update process, the control part 103 switches the state of the apparatus generally operated to the state of the program update process to stop the general operation.

Subsequently, in Step S106, the control part 103 performs the update process for the data processing program. The control part 103 applies the update data processing program distributed through the external recording medium 121 or the server 131, applies both of the update process executing program core and the update process executing program body, and performs the update process for the old data processing program stored in the storage part 110. More specifically, the control part 103 performs the process in which a part of a program or parameters of the old data processing program are replaced by a new program or parameters included in the update data processing program in accordance with an algorithm specified by the update process executing program body, or an algorithm specified by both of the update process executing program core and the update process executing program body.

The update data processing program is formed of a plurality of update files grouped, in which both of the update process executing program core and the update process executing program body are executed to take the files out of the group of data on the memory (RAM) 102 in proper units and order and to write the files to the storage part 110 configured of a flash ROM.

In Step S107, if the control part 103 confirms that all the update processes are completed, the control part 103 checks update error, for example, it compares the values of sums, and confirms that the update process is successfully performed. The process goes to Step S108, the control part 103 turns off the flag of writing the data processing program to complete the update process. In addition, the control part 103 displays the indication to the user interface 101 showing that the update process is completed.

As described above, in the information processing apparatus according to the embodiment of the invention, it is configured in which the update process executing program (updater) is categorized into two programs, that is, the core program which is the first program and the body program which is the second program, these programs are classified into the following settings: the update process executing program core that is the update process executing program common to the data processing programs different in individual versions of products or individual destination countries, and the update process executing program body that is the update process executing program unique to the data processing program corresponding to each of the data processing programs different in individual versions of products or individual destination countries, the update process executing program core is recorded in advance in the information processing apparatus, and the update process executing program body is also distributed to the information processing apparatus when the program for adding a function of the data processing program or for correcting the data processing program is distributed. Thus, the update process executing program core that is initially installed in the information processing apparatus can be common to apparatuses, which leads to eliminating the necessity to create and store update process executing programs corresponding to all the data processing programs with the development and sales of apparatuses, leading to cost reduction. In addition, only the update process executing program core, not including the update process executing program body, is stored in the storage part of the information processing apparatus, and then the storage capacity of the storage part of the information processing apparatus is not wasted.

In addition, in the update process for the data processing program to which the update process executing program body is applied, such a configuration may be possible that the control part 101 acquires device configuration information of the information processing apparatus 100, for example, the control part 101 acquires at least any one of items of configuration information of hardware and software provided in the information processing apparatus 100 from the storage part 110 to perform the update process for the data processing program.

In addition, in the embodiment above, an example of the update process for the data processing program is described. However, such a configuration may be possible that the update process executing program body is configured to be an update process executing program for the update process executing program core, and the control part 101 applies the update process executing program body to perform the update process for the update process executing program core stored in the storage part 110.

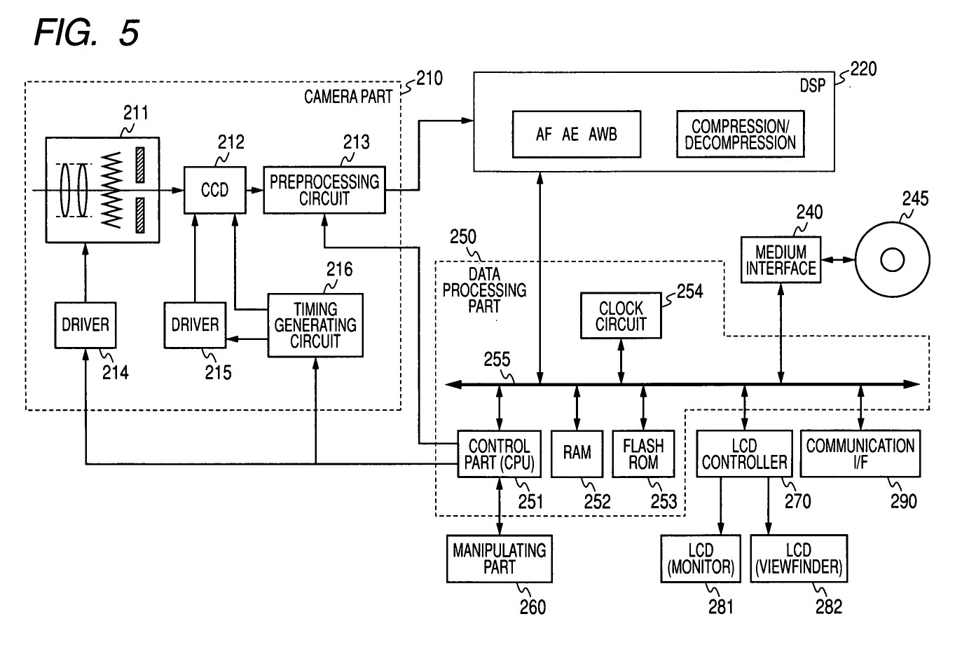

Lastly, the configuration of a digital still camera (imaging apparatus), which is an example of the information processing apparatus according to the embodiment of the invention, will be described with reference to FIG. 5. As shown in FIG. 5, the digital still camera is mainly provided with a camera part 210, a DSP (Digital Signal Processor) 220, a medium interface 240, a data processing part 250, a manipulating part 260, an LCD (Liquid Crystal Display) controller 270, an LCD (monitor) 281, an LCD (viewfinder) 282, a communication interface 290, and an internal memory 300, and a recording medium 245 detachably mounted.

For example, the recording medium 245 is a so-called memory card using a semiconductor memory, an optical recording medium such as a recordable DVD (Digital Versatile Disc) and a recordable CD (Compact Disc), and a magnetic disk. As the recording medium 245, a recording medium for recording taken images is mounted when the digital still camera is normally used, but in the update process for the data processing program described above, a recording medium having the update data processing program and the update process executing program body stored thereon is mounted.

In addition, the data processing program and the update process executing program core matched with the apparatus is stored in a flash ROM 253, which is a non-volatile memory in the data processing part 250 shown in the drawing. In addition, the user interface 101 shown in FIG. 1 is configured of the LCD (monitor) 281 and the manipulating part 260 in the configuration shown in FIG. 5.

As shown in FIG. 5, the camera part 210 has an optical block 211, CCD (Charge Coupled Device) 212, a preprocessing circuit 213, an optical block driver 214, a CCD driver 215, and a timing generating circuit 216. Here, the optical block 211 has a lens, a focus mechanism, a shutter mechanism, and an iris mechanism.

In addition, the data processing part 250 is a microcomputer configured in which a control part (CPU: Central Processing Unit) 251, a RAM (Random Access Memory) 252 as an internal memory, the flash ROM (Read Only Memory) 253, and a clock circuit 254 are connected to each other through a system bus 255, and the data processing part 250 can control the individual components of the digital still camera according to the embodiment. The flash ROM 253 stores therein the data processing program and the update process executing program core for executing various processes in the CPU 251, and parameters necessary for data processing in addition to these.

The RAM (Random Access Memory) 252 as an internal memory is used for a work area and a storage area for parameters in data processing, and in the update process for the data processing program, in the RAM 252, the update process executing program core read out of the flash ROM 253 and the update process executing program body acquired through the medium (recording medium) 245 or the server accessed via the communication I/F 290 are temporarily recorded.

In imaging pictures, in accordance with control from the control part 251, the optical block driver 214 generates a drive signal to operate the optical block 211, and supplies it to the optical block 211 to operate the optical block 211. In response to the drive signal from the driver 214, the focus mechanism, the shutter mechanism, and the iris mechanism are controlled in the optical block 211, a subject image is taken, and the image is supplied to CCD 212.

The CCD 212 is a component that photoelectrically converts the image from the optical block 211 and outputs it, which works in response to the drive signal from the CCD driver 215, takes the subject image from the optical block 211, and supplies the taken subject image (image information) as electric signals to the preprocessing circuit 213 based on a timing signal from the timing generating circuit 216 controlled by the control part 251.

In accordance with control from the control part 251, the timing generating circuit 216 generates a timing signal. In addition, the CCD driver 215 generates a drive signal supplied to the CCD 212 based on the timing signal from the timing generating circuit 216.

The preprocessing circuit 213 applies CDS (Correlated Double Sampling) processing to the image information of electric signals supplied thereto to excellently maintain the signal-to-noise ratio as well as applies AGC (Automatic Gain Control) processing thereto to control the gain, and then, performs A/D (Analog/Digital) conversion to generate image data of digital signals.

The image data converted into digital signals in the preprocessing circuit 213 is supplied to the DSP 220. The DSP 220 applies camera signal processing such as AF (Auto Focus), AE (Auto Exposure), and AWB (Auto White Balance) to the supplied image data. The image data variously adjusted is compressed by a predetermined compression method, supplied to the recording medium 245 through the system bus 255 and the medium I/F 240, and recorded as a file on the recording medium 245.

In addition, in accordance with a manipulation input from a user accepted through the manipulating part 260 formed of a touch panel and a control key, in the image data recorded on the recording medium 245, the targeted image data is read out of the recording medium 245 through the medium I/F 240, and supplied to the DSP 220.

The DSP 220 applies data decompression processing to the image data having compressed, which has been read out of the recording medium 245 and supplied through the medium I/F 240, and supplies the image data after decompressed to the LCD controller 270 through the system bus 255. The LCD controller 270 generates image signals to be supplied to the LCDs 281 and 282 from the supplied image data, and supplies them to the LCDs 281 and 282. Thus, an image in accordance with the image data recorded on the recording medium 245 is displayed on the display screens of the LCDs 281 and 282.

In addition, the digital still camera is provided with the communication I/F 290. The digital still camera is connected to an external server, for example, through the communication I/F 290, and receives the supply of the update data processing program and the update process executing program body from the server to update the data processing program based on the supplied programs.

In addition, an exemplary hardware configuration of the information processing apparatus shown in FIG. 5 is an example of the apparatus. The configuration is not limited to the configuration shown in FIG. 5, and various apparatuses are applicable.

As discussed above, the embodiment of the invention is described in detail with reference to specific implementations. However, it is obvious that those skilled in the art can make alternations and substitutions within the scope of the teachings of the embodiment of the invention. In other words, the embodiment of the invention has been disclosed in the form of exemplifications, which should not be interpreted in a limited manner. In order to evaluate the teachings of the embodiment of the invention, the appended claims should be considered.

In addition, a sequence of the process steps described in the specification may be implemented by hardware, or software, or the combination of both. In the case in which the process steps are implemented by software, a program recorded with the process sequence can be installed in a memory inside a computer mounted in dedicated hardware for execution, or the program can be installed in a multi-purpose computer executable of various processes for execution. For example, the program can be recorded in advance on a recording medium. In addition to the installation of the program from the recording medium to the computer, the program can be received over a network such as a LAN (Local Area Network), or the Internet, and installed on a recording medium such as a built-in hard disk.

In addition, various processes described in the specification may be performed in a time series as well as they may be performed in parallel or separately depending on the processing performance of the apparatus performing the processes or as necessary. In addition, the system described in the specification is the configuration of logical assembly of a plurality of devices, which is not limited to those having the devices of the individual configurations in the same cabinet.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a storage part configured to store therein an update process executing program core which is a partial program configuring an update process executing program applied to an update process for a data processing program stored in the information processing apparatus; and
a control part configured to start the update process executing program core in the update process for the data processing program, acquire an update process executing program body which is a partial program configuring the update process executing program through a recording medium or over a network, and apply the update process executing program body to perform the update process for the data processing program.

2. The information processing apparatus according to claim 1,
wherein the update process executing program core stored in the storage part is a program stored as a program common to information processing apparatuses having a plurality of different data processing programs, and
the update process executing program body acquired through the recording medium or over the network is a program set as it corresponds to individual data processing programs in order to perform different update processes corresponding individually to the different data processing programs.

3. The information processing apparatus according to claim 1,
wherein the update process executing program core stored in the storage part is a program which performs a hardware initialization process necessary for the update process for the data processing program executed in the information processing apparatus and the acquiring process for the update process executing program body.

4. The information processing apparatus according to claim 1,
wherein the control part loads the update process executing program body acquired through the recording medium or over the network to a ROM of the information processing apparatus to perform the update process for the data processing program to which the update process executing program body is applied, and
after the update process, the control part ends the update process without recording the update process executing program body in the storage part.

5. The information processing apparatus according to claim 1,
wherein the storage part has a configuration in which device configuration information of the information processing apparatus is stored, and
the control part applies the update process executing program body to acquire the device configuration information and performs the update process for the data processing program.

6. The information processing apparatus according to claim 5,
wherein the device configuration information includes at least any of items of configuration information of hardware and software provided in the information processing apparatus.

7. The information processing apparatus according to claim 1,
wherein the control part applies the update process executing program body to perform an update process of the update process executing program core.

8. An update method of a data processing program comprising the steps of:
starting an update process executing program core applied to an update process for a data processing program stored in the information processing apparatus and acquiring an update process executing program body which is a partial program configuring the update process executing program through a recording medium or over a network; and
applying the update process executing program body and performing the update process for the data processing program.

9. A program which allows a computer to perform an update method of a data processing program, the method comprising the steps of:
starting an update process executing program core applied to an update process for a data processing program stored in the information processing apparatus and acquiring an update process executing program body which is a partial program configuring the update process executing program through a recording medium or over a network; and
applying the update process executing program body and performing the update process for the data processing program.
